(19) United States
(12) Patent Application Publication
(10) Pub. No.: US 2023/0027695 A1
(43) Pub. Date: Jan. 26, 2023

(54) ELECTROCHEMICAL BATTERY DEVICE WITH IMPROVED LIFETIME, COMPRISING IMPROVED SEALING AND ELECTRICAL CONDUCTION MEANS, AND MANUFACTURING METHOD THEREOF

(71) Applicant: I-TEN, Dardilly (FR)

(72) Inventors: Fabien Gaben, Dardilly (FR); Ian CAYREFOURCQ, Villefontaine (FR)

(21) Appl. No.: 17/788,461

(22) PCT Filed: Dec. 23, 2020
(86) PCT No.: PCT/IB2020/062374

§ 371 Date: Jun. 23, 2022

(30) Foreign Application Priority Data
Dec. 24, 2019 (FR) 1915548

(51) Int. Cl. H01M 50/141; H01M 50/103; H01M 50/121; H01M 50/122; H01M 50/117

(52) U.S. Cl. CPC H01M 50/141; H01M 50/103; H01M 50/121; H01M 50/122; H01M 50/117

(57) ABSTRACT

A battery including a stack alternating between at least one anode and at least one cathode, a primary encapsulation system covering some of the faces of the stack, at least one anode contact member operable to make electrical contact between the stack and an external conductive element, and at least one cathode contact member operable to make an electrical contact between the stack and an external conductive element. An additional encapsulation system includes two frontal regions respectively covering a respective frontal region of the primary encapsulation system and two lateral regions which cover a respective lateral region devoid of any contact member of the primary encapsulation system. Each of the two frontal regions of the additional encapsulation system further cover the frontal ends respectively of the anode contact members and the cathode contact members. The frontal regions of the additional encapsulation system form a surface continuity with the lateral regions of the additional encapsulation system.

### CROSS-REFERENCE TO RELATED APPLICATIONS

The present application is a National Stage Application of PCT International Application No. PCT/IB2020/062374 (filed on Dec. 23, 2020), under 35 U.S.C. § 371, which claims priority to French Patent Application No. 1915548 (filed on Dec. 24, 2019), which are each hereby incorporated by reference in their complete respective entireties.

### TECHNICAL FIELD

The present invention relates to electrochemical devices of the battery type. It can in particular be applied to lithium-ion batteries. The invention relates to a novel battery architecture, which gives batteries improved impervious sealing and electrical conduction properties and a longer life. The invention further relates to a method for manufacturing these batteries.

### BACKGROUND

Some types of batteries, an in particular some types of thin-film batteries, need to be encapsulated in order to have a long life because oxygen and moisture cause degradation thereto. In particular, lithium-ion batteries are very sensitive to moisture. The market demands a product life of more than 10 years; an encapsulation must thus be provided to guarantee this life.

Thin-film lithium-ion batteries are multi-layer stacks comprising electrode and electrolyte layers typically between about one μm and about ten μm thick. They can comprise a stack of a plurality of unit cells. These batteries are seen to be sensitive to self-discharge. Depending on the positioning of the electrodes, in particular the proximity of the edges of the electrodes for multi-layer batteries and the cleanness of the cuts, a leakage current can appear at the ends, i.e. a creeping short-circuit which reduces battery performance. This phenomenon is exacerbated if the electrolyte film is very thin.

These solid-state thin-film lithium-ion batteries usually use anodes having a lithium metal layer. The volume of the anode materials is seen to vary significantly during charge and discharge cycles of the battery. More specifically, during a charge and discharge cycle, part of the lithium metal is transformed into lithium ions, which are inserted into the structure of the cathode materials, which is accompanied by a reduction in the volume of the anode. This cyclic variation in volume can deteriorate the mechanical and electrical contacts between the electrode and electrolyte layers. This reduces battery performance during its life.

The cyclic variation in the volume of the anode materials also induces a cyclic variation in the volume of the battery cells. It thus generates cyclic stresses on the encapsulation system, which are liable to initiate cracks causing a loss of imperviousness (or even a loss of integrity) of the encapsulation system. This phenomenon is yet another cause of reduced battery performance during the life thereof.

More specifically, the active materials of lithium-ion batteries are very sensitive to air and in particular to moisture. Mobile lithium ions react spontaneously with traces of water to form LiOH, resulting in calendar ageing of the batteries. The quantity of lithium having reacted with the water is no longer available for storing energy, which reduces the capacity of the battery through premature ageing. For this purpose, utmost care must be taken when manufacturing the batteries in order to maintain perfectly anhydrous conditions. Similarly, to guarantee the calendar life thereof, the batteries are protected from the external environment by a hermetic encapsulation that prevents water permeation that could lead to a further reduction in battery capacity.

Water permeation through this encapsulation structure is a well-known phenomenon. The imperviousness of an encapsulation is usually expressed as a water vapour transmission rate (WVTR). This rate depends on the materials used, the way they are manufactured and the thicknesses thereof.

The quality of the encapsulation is of utmost importance for lithium-ion batteries.

Moreover, all lithium ion-conductive electrolytes and insertion materials are non-reactive to moisture. By way of example, Li₄Ti₅O₁₂ does not deteriorate when in contact with the atmosphere or traces of water. By contrast, as soon as it is filled with lithium in the form Li₄₊ₓTi₅O₁₂, where x>0, the inserted lithium surplus (x) is sensitive to the atmosphere and reacts spontaneously with traces of water to form LiOH. The reacted lithium is thus no longer available for storing electricity, resulting in a loss of capacity of the battery.

To prevent exposure of the active materials of the lithium-ion battery to air and water and to prevent this type of ageing, it must be protected with an encapsulation system. Numerous encapsulation systems for thin-film batteries are described in the literature.

U.S. Patent Publication No. 2002/0071989 describes an encapsulation system for a solid-state thin-film battery comprising a stack of a first layer of a dielectric material selected from among alumina (Al₂O₃), silica (SiO₂), silicon nitride (Si₃N₄), silicon carbide (SiC), tantalum oxide (Ta₂O₅) and amorphous carbon, a second layer of a dielectric material and an impervious sealing layer disposed on the second layer and covering the entire battery.

U.S. Pat. No. 5,561,004 describes a plurality of systems for protecting a thin-film lithium-ion battery. A first proposed system comprises a parylene layer covered with an aluminium film deposited on the active components of the battery. However, this system for protecting against air and water vapour diffusion is only effective for about a month. A second proposed system comprises alternating layers of parylene (500 nm thick) and metal (about 50 nm thick). The document states that it is preferable to coat these batteries again with an ultraviolet-cured (UV-cured) epoxy coating to reduce the speed at which the battery is degraded by atmospheric elements.

Reference is also made to the International Patent Publication No. WO 2019/002768, filed by the Applicant, which describes a typical arrangement of an electrochemical device. As disclosed in this document, such a device comprises a unit stack, each cell whereof comprises anode and respectively cathode current-collecting substrates, anode and respectively cathode layers, and at least one layer of an electrolyte material or of a separator impregnated with an electrolyte. Anode and respectively cathode contacts are provided on the opposing lateral faces of this stack.

Finally, mention is made of U.S. Patent Publication No. 2019/368141, which discloses a battery intended to be integrated into a road. This battery comprises an encapsulation 150, as well as curbs 160 to keep the elements of the battery contained within the road structure.

According to the prior art, most lithium-ion batteries are encapsulated in metallised polymer foils (called “pouches”) enclosed around the battery cell and heat-sealed at the connector tabs. These packagings are relatively flexible and the positive and negative connections of the battery are thus embedded in the heat-sealed polymer that was used to seal the packaging around the battery. However, this weld between the polymer foils is not totally impervious to atmospheric gases, since the polymers used to heat-seal the battery are relatively permeable to atmospheric gases. Permeability is seen to increase with the temperature, which accelerates ageing.

However, the surface area of these welds exposed to the atmosphere remains very small, and the rest of the packaging is formed by aluminium foils sandwiched between these polymer foils. In general, two aluminium foils are combined to minimise the effects of the presence of holes, which constitute defects in each of these aluminium foils. The probability of two defects on each of the strips being aligned is greatly reduced.

These packaging technologies guarantee a calendar life of about 10 to 15 years for a 10 Ah battery with a 10×20 cm2 surface area, under normal conditions of use. If the battery is exposed to a high temperature, this life can be reduced to less than 5 years, which is insufficient for many applications. Similar technologies can be used for other electronic components, such as capacitors and active components.

As a result, there is a need for systems and methods for encapsulating thin-film batteries and other electronic components that protect the component from air, moisture and the effects of temperature. There is in particular a need for systems and methods for encapsulating thin-film lithium-ion batteries to protect them from air and moisture as well as from deterioration when the battery is subjected to charge and discharge cycles. The encapsulation system must be impervious and hermetically-sealed, it must completely enclose and cover the component or the battery, must be flexible enough to accommodate slight changes in the dimensions of the battery cell (“breaths”), and it must also allow the edges of electrodes of opposite polarities to be galvanically separated in order to prevent any creeping short-circuit.

### SUMMARY

One purpose of the present invention is to overcome, at least in part, the aforementioned drawbacks of the prior art.

Another purpose of the present invention is to propose lithium-ion batteries with a very long life and a low self-discharge rate.

It in particular aims to propose a method that allows electronic or electrochemical devices, such as batteries, with a very long life to be manufactured in a simple, easy to implement, reliable and fast manner. It in particular aims to propose a method that reduces the risk of a short-circuit, and that in particular allows an electrochemical device, such as a battery, with a low self-discharge rate and a very long life to be manufactured.

At least one of the above purposes is achieved through at least one of the objects according to the invention as described hereinbelow. The present invention provides as a first object a battery (1000), said battery comprising:

a stack (I) alternating between at least one anode (20) and at least one cathode (50), each formed by a stack of thin layers,

wherein the anode (20) comprises: at least one anode current-collecting substrate (21), at least one thin layer of an anode active material (22), and optionally a thin layer of an electrolyte material (23) or of a separator impregnated with an electrolyte (23′),

wherein the cathode (50) comprises: at least one cathode current-collecting substrate (51), at least one thin layer of a cathode active material (52), and optionally a thin layer of an electrolyte material (53) or of a separator impregnated with an electrolyte (53′),

such that said stack successively comprises at least one anode current-collecting substrate (21), at least one thin layer of an anode active material (22), at least one thin layer of an electrolyte material (23, 53) or of a separator impregnated with an electrolyte (23′, 53′), at least one thin layer of a cathode active material (52), and at least one cathode current-collecting substrate (51),

said stack (I) defining six faces, i.e.:
two so-called frontal faces (F1, F2) that are opposite one another and in particular parallel to one another, generally parallel to the thin layers of anode active material (22), to the thin layers of electrolyte material (23, 53) or of separator impregnated with an electrolyte (23′, 53′), and to the thin layers of cathode active material (52), and
four so-called lateral faces (F3, F4, F5, F6) opposite one another in pairs, in particular parallel to one another in pairs,
a so-called primary encapsulation system (1020) covering at least two of the six faces of said stack (I), this encapsulation system comprising two frontal encapsulation regions (1021, 1022) covering all or part of said frontal faces (F1, F2), and/or two lateral encapsulation regions (1023, 1025) covering all or part of two of said lateral faces (F3, F5), the lateral encapsulation regions preferably being opposite one another, in particular parallel to one another,
at least one anode contact member (1040), capable of making the electrical contact between the stack and an external conductive element, said anode contact member covering at least in part a first (F4) of the two lateral faces (F4, F6) not covered by the primary encapsulation system (1020), said first face (F4) defining at least one anode connection zone,
at least one cathode contact member (1050), capable of making the electrical contact between the stack and an external conductive element, said cathode contact member covering at least in part a second (F6) of the two lateral faces not covered by the primary encapsulation system (1020), said second face (F6) defining at least one cathode connection zone,

said anode (1040) and cathode (1050) contact members preferably being opposite one another, in particular parallel to one another,

said battery being characterised in that it further comprises a so-called additional encapsulation system (1030), this additional encapsulation system comprising two frontal regions (1031, 1032), each whereof covers an frontal face of the stack with the optional interposition of a respective frontal region (1021, 1022) of the primary encapsulation system, this additional encapsulation system further comprising two lateral regions (1033, 1035), each whereof covers a lateral face of the stack, with the optional interposition of a respective lateral region (1023, 1025), devoid of any contact member, of the primary encapsulation system,
each of said two frontal regions (1031, 1032) of the additional encapsulation system (1030) further covering the frontal ends (1041, 1042, 1051, 1052) respectively of the anode contact members and of the cathode contact members,
each of the frontal regions (1031, 1032) of the additional encapsulation system forming a surface continuity with the lateral regions (1033, 1035) of said additional encapsulation system.

According to other features of the battery according to the invention, which may be taken in isolation or according to any technically compatible feature:

said primary encapsulation system comprises two frontal encapsulation regions (1021, 1022) covering all or part of said frontal faces (F1, F2), and two lateral encapsulation regions (1023, 1025) covering all or part of two of said lateral faces (F3, F5),

said primary encapsulation system comprises only two frontal encapsulation regions (1021, 1022) covering all or part of said frontal faces (F1, F2).,

said primary encapsulation system comprises only two lateral encapsulation regions (1023, 1025) covering all or part of two of said lateral faces (F3, F5),

each of the two frontal regions of the additional encapsulation system delimits two projecting edges (1031A, 1031B, 1032A, 1032B) each whereof projects from the respective frontal region of the primary encapsulation system, along a lateral axis (X) of the stack, each projecting edge covering a respective end of the anode contact member or of the cathode contact member,

along said lateral axis (X) of the stack, said primary encapsulation system extends to the inner face of the contact members, whereas said additional encapsulation system extends beyond said inner face, in particular as far as the outer face of these contact members,

each of the two frontal regions of the additional encapsulation system delimits two projecting rims (1031C, 1031D, 1032C, 1032D), each whereof projects, along another lateral axis (Y) of the stack, both from the respective frontal region of the primary encapsulation system and from the anode and cathode contact members, said projecting rims ensuring said surface continuity between the frontal regions and the lateral regions of the additional encapsulation system,

the opposite ends (1041, 1042, 1051, 1052) of each respectively anode (1040) and cathode (1050) contact member, are flush with the frontal regions (1021, 1022) of the primary encapsulation system (1020),

the primary encapsulation system (1020) comprises at least one first cover layer, preferably chosen from among parylene, parylene F, polyimide, epoxy resins, silicone, polyamide, sol-gel silica, organic silica and/or a mixture thereof, disposed on the stack (I),

each of the anode contact member (1040) and of the cathode contact member (1050) comprises a first electrical connection layer made of a material filled with electrically conductive particles and a second electrical connection layer comprising a metal foil or a metal layer, disposed on the first electrical connection layer,

the additional encapsulation system (1030) comprises an encapsulation layer selected from among glasses, ceramics and glass ceramics, said encapsulation layer preferably having a water vapour permeance (WVTR) of less than 10-5 g/m2.d,

the glasses, ceramics and glass ceramics of the encapsulating layer are selected from among:
low melting point glasses, preferably chosen from among SiO₂—B₂O₃; Bi₂O₃—B₂O₃, ZnO—Bi₂O₃—B₂O₃, TeO₂—V₂O₅, and PbO—SiO₂,
oxides and/or nitrides and/or Ta₂O₅ and/or alumina (Al₂O₃) and/or oxynitrides and/or SixNy and/or SiO₂ and/or SiON and/or amorphous silicon and/or SiC.

The invention also relates to a method of manufacturing the above battery, said manufacturing method comprising:

a) supplying at least one anode current-collecting substrate foil coated with an anode layer, and optionally coated with a layer of an electrolyte material or a separator impregnated with an electrolyte, hereinafter referred to as an anode foil,

b) supplying at least one cathode current-collecting substrate foil coated with a cathode layer, and optionally coated with a layer of an electrolyte material or a separator impregnated with an electrolyte, hereinafter referred to as a cathode foil,

c) producing said stack (I) alternating at least one anode foil and at least one cathode foil to successively obtain at least one anode current-collecting substrate, at least one anode layer, at least one layer of an electrolyte material or of a separator impregnated with an electrolyte, at least one cathode layer, and at least one cathode current-collecting substrate,

d) heat treating and/or mechanically compressing the stack of alternating foils obtained in step c), so as to form a consolidated stack,

e) producing said so-called primary encapsulation system (1020), so as to form an encapsulated and cut stack exposing at least the anode and cathode connection zones, preferably at least the faces defining the anode and cathode connection zones,

f) optionally, impregnating the cut and encapsulated stack with a phase carrying lithium ions such as liquid electrolytes or an ionic liquid containing lithium salts, such that said separator is impregnated with an electrolyte,

g) placing each of the anode and cathode contact members on a respective lateral face of the stack not covered with the primary encapsulation system,

h) producing an additional encapsulation assembly (1030′) on the structure obtained after step g), intended to encapsulate the consolidated stack including the contact members, and

i) at least partially exposing the anode and cathode contact members so as to form said additional encapsulation system (1030).

According to other features of the battery according to the invention, which may be taken in isolation or according to any technically compatible feature:

this method further comprising producing a so-called primary encapsulation assembly (1020′) on the consolidated stack (I), said primary encapsulation system being produced from said primary encapsulation assembly,

the primary encapsulation system is produced from the primary encapsulation assembly by making two so-called primary cuts along first cutting planes (II II),

the additional encapsulation system is produced from the additional encapsulation assembly by making two so-called additional cuts along second cutting planes (V V) extending outside the first cutting planes,

the at least partial exposure of the anode and cathode contact members according to step i) of the method is carried out by polishing or by cutting,

the production of the so-called primary encapsulation system (1020) comprises the deposition of at least one first cover layer, preferably chosen from among parylene, parylene F, polyimide, epoxy resins, silicone, polyamide, sol-gel silica, organic silica and/or a mixture thereof, on the stack (I),

the production of the additional encapsulation system intended to encapsulate the consolidated stack including contact members, comprises the deposition of an encapsulation layer selected from among glasses, ceramics and glass ceramics,

the glasses, ceramics and glass ceramics are selected from among:
low melting point glasses, preferably chosen from among SiO₂—B₂O₃; Bi₂O₃—B₂O₃, ZnO—Bi₂O₃—B₂O₃, TeO₂—V₂O₅, and PbO—SiO₂,
oxides and/or nitrides and/or Ta₂O₅ and/or alumina (Al₂O₃) and/or oxynitrides and/or SixNy and/or SiO₂ and/or SiON and/or amorphous silicon and/or SiC,

the production of anode and cathode contact members comprises:
depositing, on at least the anode connection zone and at least the cathode connection zone, a first electrical connection layer made of a material filled with electrically conductive particles, said first layer preferably being made of polymeric resin and/or a material obtained by a sol-gel method filled with electrically conductive particles,
optionally, when said first layer is made of polymeric resin and/or a material obtained by a sol-gel method filled with electrically conductive particles, a drying step followed by a step of polymerising said polymeric resin and/or said material obtained by a sol-gel method, and
depositing, on the first layer, a second electrical connection layer disposed on the first electrical connection layer, said second electrical connection layer preferably comprising a metal foil or a metal ink, bearing in mind that in the latter case, said drying step can alternatively be carried out after the deposition of said second electrical connection layer,

the production of an alternating succession of respectively cathode and anode strata, each stratum comprising a plurality of so-called empty zones, as well as the making of cuts making it possible to separate a given stack of a battery from at least one other stack of another battery,

if the empty zones have bars connected in pairs by channels, at least part of the bars is filled with encapsulation material, then said cuts are made so as to obtain stacks having two opposite lateral faces coated with said encapsulation material,

if the empty zones have an overall I shape, at least one line formed by a plurality of stacks is produced, the frontal faces of this line are at least partially covered with encapsulation material, and said cuts are made so as to obtain stacks having frontal faces coated with said encapsulation material.

According to the invention, the encapsulation is provided by two separate encapsulation systems. These systems are different, in particular in terms of the dimensions thereof. More specifically, the additional encapsulation system has larger dimensions than the primary encapsulation systems, allowing it to project from this primary system in at least one direction in space. Furthermore, these two systems are advantageously different in terms of the material of which they are made and the dimensions thereof. The combination of these separate encapsulation systems procures, inter alia, a particularly satisfactory imperviousness. Furthermore, according to the invention, the additional system can be produced after the contact members have been positioned.

It should be noted that the prior art does not disclose such a combination between separate encapsulation systems. In particular, this combination does not appear in the teachings of the aforementioned International Patent Publication No. WO 2019/002768. In essence, this prior art document uses a single encapsulation system, as mentioned in the main claim thereof.

### DRAWINGS

Certain aspects of the invention and embodiments of the invention are shown with reference to the accompanying figures, which are given as non-limiting examples only, in which:

FIG. 1 diagrammatically shows a front view with cutaway of a stack (I) defining 6 faces, the precursor of a battery according to the invention, successively comprising at least one anode current-collecting substrate (21), at least one thin layer of an anode active material (22), at least one thin layer of an electrolyte material (23, 53) or of a separator impregnated with an electrolyte (23′, 53′), at least one thin layer of a cathode active material (52), and at least one cathode current-collecting substrate (51).

FIG. 2 diagrammatically shows a front view with cutaway of a stack encapsulated in a primary encapsulation system.

FIG. 3 diagrammatically shows a front view with cutaway of a stack encapsulated in a primary encapsulation system, the anode and cathode connection zones whereof have been exposed along the cutting planes II-II which are visible in FIG. 2.

FIG. 4 diagrammatically shows a front view with cutaway of a stack, the precursor of a battery, showing the internal structure of the stack covered by a primary encapsulation system and that of the contact members according to the invention.

FIG. 5 diagrammatically shows a front view with cutaway of a stack encapsulated in a primary encapsulation system and in a so-called additional encapsulation system showing the internal structure of the battery.

FIG. 6 diagrammatically shows a front view with cutaway of a stack encapsulated in a primary encapsulation system and in a so-called additional encapsulation system showing the internal structure of the battery, the anode and cathode connection zones whereof have been exposed along the cutting planes V-V which are visible in FIG. 5.

FIG. 7 diagrammatically shows a side view of a battery according to the invention showing the external face of an anode contact member surrounded, on the periphery thereof, by the additional encapsulation system.

FIGS. 8 and 9 are sectional views showing alternative embodiments of the invention, wherein the primary encapsulation system covers only 2 faces of the unit stack.

FIGS. 10 and 11 are perspective views showing anode and cathode foils which are arranged in a superimposed manner, present in two alternative embodiments of a method for manufacturing a battery according to the invention.

FIG. 12 is a front view, showing a step in the production of the battery according to the alternative embodiment in FIG. 8.

FIGS. 13 and 14 are front views showing steps in the production of the battery according to the alternative embodiment in FIG. 9.

### DESCRIPTION

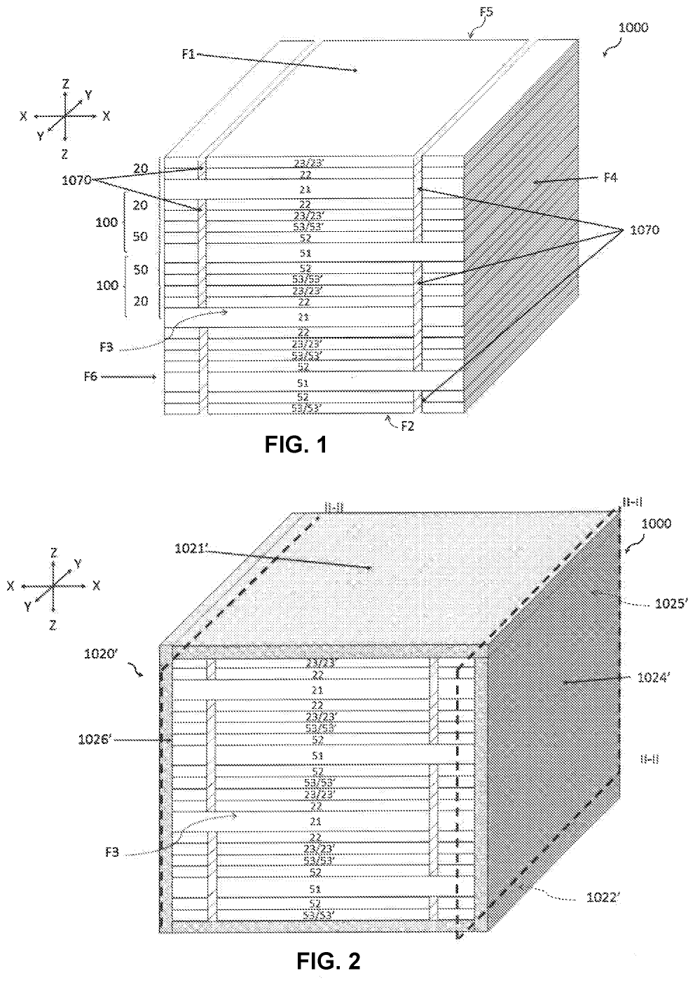

FIG. 1 shows an electrochemical device according to a first alternative embodiment, which is a battery denoted as a whole by the reference numeral 1. This battery comprises, in a manner known per se, a stack (I) alternating between at least one anode (20) and at least one cathode (50).

This anode (20) comprises at least one anode current-collecting substrate (21), and at least one thin layer of an anode active material (22). In the example shown, this anode further comprises a thin layer of an electrolyte material (23) or of a separator impregnated with an electrolyte (23′), which is however optional.

Furthermore, the cathode (50) comprises at least one cathode current-collecting substrate (51), and at least one thin layer of a cathode active material (52). This cathode further comprises, in the example shown, a thin layer of an electrolyte material (53) or of a separator impregnated with an electrolyte (53′), which is however optional.

As a result, the aforementioned stack successively comprises at least one anode current-collecting substrate (21), at least one thin layer of an anode active material (22), at least one thin layer of an electrolyte material (23, 53) or of a separator impregnated with an electrolyte (23′, 53′), at least one thin layer of a cathode active material (52), and at least one cathode current-collecting substrate (51).

Advantageously, after the stack has been produced, the battery can be assembled by heat treatment and/or mechanical compression. The heat treatment of the stack enabling the battery to be assembled is advantageously carried out at a temperature comprised between 50° C. and 500° C., preferably at a temperature below 350° C. Mechanical compression of the stack is advantageously carried out at a pressure comprised between 10 MPa and 100 MPa, preferably between 20 MPa and 50 MPa.

This stack I, which is parallelepipedal overall, has six faces. The opposing so-called end or frontal faces which, by convention, are substantially parallel to the different layers above, are firstly denoted by the references F1 and F2. The stack 2 also defines four lateral faces F3 to F6, which are parallel and opposite one another in pairs. An orthogonal coordinate system XYZ associated with this stack is defined, wherein the Z direction is said to be frontal, in that it is perpendicular to the frontal faces above, whereas the other X and Y directions are said to be lateral.

This stack can be produced by any suitable method. The architecture of the battery comprising a primary encapsulation system, an additional encapsulation system and contact members according to the invention, is particularly adapted to stacks with laterally opposed anode and cathode connection zones. In the example shown in FIG. 1, representing a first embodiment of the stack, the layers forming the stack have recesses (1070) such that each unit cell defines a zone of continuity of the cathode current collector allowing electrical contact to be made at the cathode connection zone and a zone of continuity of the anode current collector allowing electrical contact to be made at the anode connection zone. This arrangement enables the anode and cathode connection zones to be laterally opposite one another.

FIG. 1 shows this stack I taken separately, without the other final components of the battery. In order to produce this battery, as shown in FIG. 2, the six faces of the stack I must firstly be covered with a primary encapsulation assembly denoted by the reference numeral 1020′. The six regions forming this assembly 1020′ are denoted by the reference numerals 1021′ to 1026′, which respectively cover the six faces of the stack. This assembly 1020′ is intended to form, as will be seen hereinbelow, a primary encapsulation system 1020 for protecting the battery from the atmosphere. This primary encapsulation system is advantageously chemically stable and able to withstand a high temperature. It can be impermeable to the atmosphere to provide an additional barrier layer function; however, as will be seen hereinbelow, the main barrier layer function is provided by the additional encapsulation. The material intended to form this primary encapsulation is of any suitable type, in particular this primary encapsulation system 1020 comprises at least one first cover layer, preferably chosen from among parylene, parylene F, polyimide, epoxy resins, silicone, polyamide, sol-gel silica, organic silica and/or a mixture thereof, disposed on the stack (I).

Typically, this first cover layer is selected from the group consisting of: silicones (for example deposited by impregnation or by plasma-enhanced chemical vapour deposition from hexamethyldisiloxane (HMDSO)), epoxy resins, polyimide, polyamide, poly-para-xylylene (also called poly(p-xylylene), better known as parylene), and/or a mixture thereof. This first cover layer protects the sensitive elements of the battery from the environment thereof. The thickness of said first cover layer is preferably comprised between 0.5 μm and 3 μm.

Different parylene variants can be used. Advantageously, this first cover layer can be made from parylene C, parylene D, parylene N (CAS 1633-22-3), parylene F or a mixture of parylene C, D, N and/or F. Parylene is a dielectric, transparent, semi-crystalline material with high thermodynamic stability, excellent resistance to solvents and very low permeability. Parylene also has barrier properties to protect the battery from the external environment thereof. The protection of the battery is enhanced when this first cover layer is made from parylene F. This first cover layer is advantageously obtained from the condensation of gaseous monomers deposited by chemical vapour deposition (CVD) on the surfaces, which results in a conformal, thin and uniform covering of all of the accessible surfaces of the stack. This first cover layer is advantageously stiff; it cannot be considered to be a flexible surface.

Once the six faces of the stack have been covered by the six regions of said encapsulation assembly 1020′, the anode and cathode connection zones are exposed, by any appropriate means, according to the planes II-II in FIG. 2, which are typically parallel to the frontal faces F4 and F6. This assembly 1020′ can advantageously be produced by the successive deposition of parylene—ALD—parylene layers. The anode and cathode connection zones are preferably exposed by so-called primary cuts. These cuts preferably allow the lateral regions 1024′, 1026′ of the encapsulation assembly to be removed, resulting in the exposure of the anode and cathode connection zones, as shown in FIG. 3. Alternatively, such an exposure can be obtained by a step that is different from cutting. In particular, it can be carried out by any appropriate means, in particular by chemical etching, laser cutting (or laser ablation), femtosecond laser cutting, microperforation or stamping. Such exposure is preferably carried out by saw cutting, polishing, in particular involving the use of a felt and polishing paste, abrasion and/or plasma etching.

Once these primary cuts are complete, a stack covered with a primary encapsulation system is obtained, denoted by the reference numeral 1020. The regions forming this encapsulation system, which cover the faces F1, F2, F3 and F5 of the stack, are denoted by the reference numerals 1021, 1022, 1023 and 1025. In the case of batteries impregnated with a liquid electrolyte, the impregnation of the battery with a liquid electrolyte is advantageously carried out, after obtaining the stacks covered by a primary encapsulation system and the anode and cathode connections whereof, present on the opposing lateral faces F4 and F6 respectively, are exposed, by a phase carrying lithium ions such as liquid electrolytes or an ionic liquid containing lithium salts; this phase carrying lithium ions penetrates the porosities of the battery, in particular the separators of the battery by capillary rise.

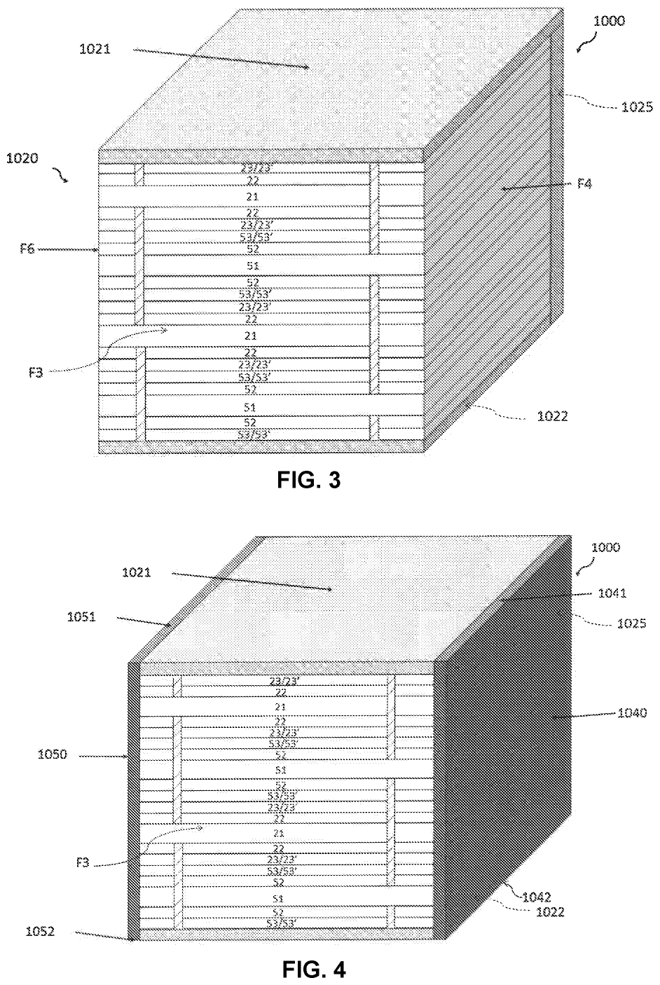

At the opposing lateral faces F4 and F6, on which the anode and cathode connection zones are exposed, and optionally after impregnation of the battery with a liquid electrolyte, anode 1040 and respectively cathode 1050 contact members are then disposed, as shown in FIG. 4. The so-called frontal ends of these contact members 1040 and 1050, which are adjacent to the frontal faces of the stack, are denoted by the reference numerals 1041 and 1042, as well as 1051 and 1052. The steps shown in FIGS. 2 to 4 are of the conventional type, and are thus not described in more detail hereinbelow.

Preferably, the contact members are deposited on and around the cathode and anode connection zones, preferably on the lateral faces defining these anode and cathode connection zones. These contact members preferably consist of a stack of layers successively comprising: a first electrical connection layer comprising a material filled with electrically conductive particles, preferably a polymeric resin and/or a material obtained by a sol-gel method, filled with electrically conductive particles and more preferably a graphite-filled polymeric resin, and a second electrical connection layer consisting of a metal foil or of a metal layer, disposed on the first layer.

The first electrical connection layer allows the subsequent second electrical connection layer to be fastened while providing “flexibility” at the connection without breaking the electrical contact when the electric circuit is subjected to thermal and/or vibratory stresses.

The second electrical connection layer is a metal foil or a metal layer. This metal foil or layer can be flat or textured. This second electrical connection layer is used to provide the batteries with lasting protection against moisture while connecting, on the one hand, the anode connection zones at the lateral face of the battery F4, and on the other hand, the cathode connection zones at the opposite lateral face of the battery F6. In general, for a given thickness of material, metals make it possible to produce highly impervious films, more impervious than ceramic-based films and even more impervious than polymer-based films, which are generally not very impervious to the passage of water molecules. It increases the calendar life of the battery by reducing the WVTR at the contact members.

Advantageously, a third electrical connection layer comprising a conductive ink can be deposited on the second electrical connection layer; the purpose thereof is to reduce the WVTR, thus increasing the life of the battery. The water vapour permeance (WVTR) can be measured using a method that is the object of the U.S. Pat. No. 7,624,621 and that is also described in the publication “Structural properties of ultraviolet cured polysilazane gas barrier layers on polymer substrates” by A. Morlier et al. published in Thin Solid Films 6+550 (2014) 85-89.

The contact members allow the electrical connections to be made alternating between positive and negative at each of the ends. These contact members enable parallel electrical connections to be made between the different battery elements. For this purpose, only the cathode connections protrude at one end, and the anode connections are available at another end.

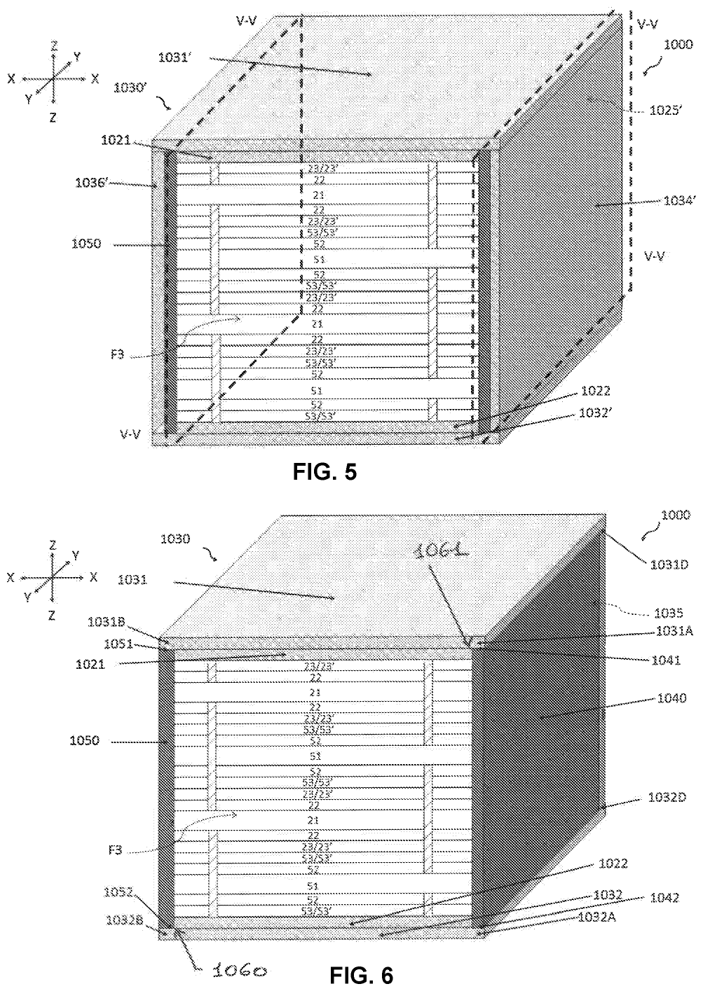

Then, as shown in FIG. 5, the six faces of the intermediate structure in FIG. 4 are covered by means of an additional encapsulation assembly 1030′ intended to form, as shown hereinbelow, an additional encapsulation system 1030. This additional encapsulation system protects the entire cell from the diffusion of molecules from the atmosphere and ultimately makes it impervious. This additional encapsulation (or additional encapsulation layer) is preferably deposited by atomic layer deposition (ALD), by PECVD, by HDPCVD (high density plasma chemical vapour deposition) or by ICP CVD (inductively coupled plasma chemical vapour deposition) in order to obtain a conformal covering of all of the accessible surfaces of the intermediate structure. As with the primary encapsulation described hereinabove, the additional encapsulation can advantageously be produced by successively depositing layers of parylene—ALD—parylene.

The thickness of this additional encapsulation layer is advantageously chosen as a function of the desired level of imperviousness to gases, i.e. the desired WVTR, and depends on the deposition technique used, chosen in particular from among ALD, PECVD, HDPCVD and ICP CVD. The thickness of this additional encapsulation layer is preferably comprised between 10 nm and 15 μm. This system or this additional encapsulation layer is impervious and preferably has a water vapour permeance (WVTR) of less than 10⁻⁵ g/m².d. The water vapour permeance can be measured using a method that is the object of the U.S. Pat. No. 7,624,621 and that is also described in the publication “Structural properties of ultraviolet cured polysilazane gas barrier layers on polymer substrates” by A. Morlier et al. published in Thin Solid Films 6+550 (2014) 85-89.

The six regions forming this additional assembly 1030′ are denoted by the reference numerals 1031′ to 1036′, which respectively cover the six faces of the stack. The material intended to form this additional encapsulation can be chosen from glasses, ceramics and glass ceramics, preferably from:

low melting point glasses, preferably chosen from among SiO₂—B₂O₃; Bi₂O₃—B₂O₃, ZnO—Bi₂O₃—B₂O₃, TeO₂—V₂O₅, and PbO—SiO₂,

oxides and/or nitrides and/or Ta₂O₅ and/or alumina (Al₂O₃) and/or oxynitrides and/or SixNy and/or SiO₂ and/or SiON and/or amorphous silicon and/or SiC.

The intermediate structure shown in FIG. 5 is then subjected to so-called additional cutting operations, carried out by any appropriate means, along the planes V-V in FIG. 5. These cutting planes are typically parallel to the planes II-II described hereinabove, however extend outside the latter in the X direction. These cuts, which preferably allow the lateral regions 1034′ 1036′ of the additional encapsulation assembly to be fully or partially removed, result in the full or partial exposure of the contact members 1040 and 1050, as shown in FIG. 6. When making these cuts, a marginal part of the material forming the contact member can also be removed, while preserving the functionality thereof. Advantageously, a sufficient part of the second electrical connection layer consisting of a metal foil is left in place. Advantageously, exposing the first electrical connection layer is also prevented.

In this context, the metal foil or metal layer can be textured to facilitate re-establishment of the electrical connection after the additional cuts have been made. Alternatively, such an exposure can be obtained by a step that is different from cutting. In particular, it can be carried out by polishing, plasma etching, chemical etching, laser cutting (or laser ablation), femtosecond laser cutting, microperforation or stamping. The use of textured metal foils is particularly advantageous when the contact members have been exposed by saw cutting or polishing, in particular using a felt and a polishing paste; this makes it easier to re-establish the electrical connection, in particular at local protuberances. Alternatively, a resist can be made on the metal part of the current collector, before producing the additional encapsulation. When this resist is removed, the electrical contact is re-exposed.

Once these additional cuts have been made, a stack firstly covered with the primary encapsulation system 1020, then covered with the additional encapsulation system 1030 is obtained. The regions forming this additional system 1030, which cover the respective regions 1021, 1022, 1023 and 1025 of the primary system 1020 are denoted by the reference numerals 1031, 1032, 1033 and 1035.

From a cross-sectional view, as shown in FIG. 6, the dimension of the frontal regions 1031 and 1032 of the additional system 1030 in the X direction is larger than the dimension of the frontal regions 1021 and 1022 of the primary system 1020. More specifically, in this X direction, each so-called primary frontal region 1021 and 1022 extends as far as the inner face of the opposite contact members 1040 and 1050. Moreover, in this direction, each so-called additional frontal region 1031 and 1032 is flush with the outer face of these contact members.

As a result, each of these regions 1031 and 1032 delimits, in this X direction, so-called projecting edges 1031A, 1031B, and 1032A, 1032B. Each of these edges 1031A, 1031B, 1032A, 1032B covers a respective end 1041, 1051, 1042, 1052 of the contact members 1040, 1050. In other words, the encapsulation material 1020, 1030, formed by both the primary and additional systems, delimits shoulders denoted by the reference numerals 1060 and 1061, against which extend the top and bottom ends respectively, of the contact members.

Furthermore, as shown in this FIG. 6, the opposite ends, respectively 1041, 1042 and 1051, 1052, of each respectively anode 1040 and cathode 1050 contact member, are flush with the frontal regions 1021 and 1022 of the encapsulation system 1020. In other words, said opposite ends extend substantially, in the X direction, at the free top face of the region 1021 and free bottom face of the region 1022 respectively.

The arrangement of the additional encapsulation system on the primary encapsulation system and around the periphery of the contact members gives the final battery excellent imperviousness, in particular a very low water vapour transmission rate. This extends the life of the battery. More particularly, this architecture makes it possible to block the diffusion of water or oxygen molecules at the ends 1042, 1041 of the contact members. More specifically, the conductive adhesives used to make the contact are not impervious to the diffusion of water molecules as can be the case with the metal foil.

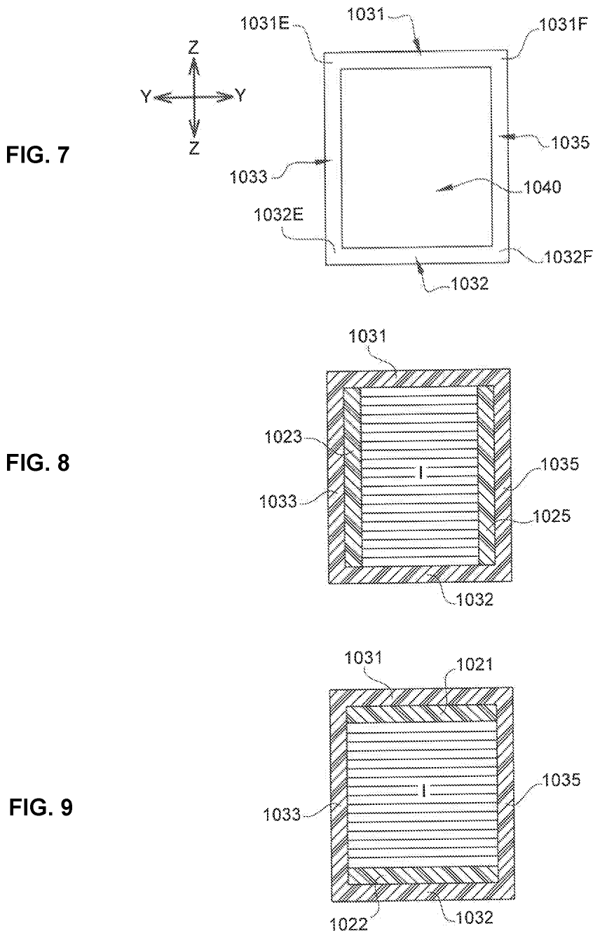

Furthermore, as shown in FIG. 7, the dimension of the frontal regions 1031 and 1032 in the Y direction is larger than the dimension of both the frontal regions 1021 and 1022 and the contact members 1040, 1050. As a result, each of these regions 1031 and 1032 delimits, in this Y direction, so-called projecting rims 1031C, 1031D, and 1032C, 1032D. These different rims procure a surface continuity of the additional encapsulation, between each frontal region 1031 or 1032 as well as the two lateral regions 1033 and 1035.

The aforementioned battery, in accordance with the embodiments shown in FIGS. 1 to 7, includes a primary encapsulation system having four regions, each whereof covers a respective face of the primary stack. Alternatively however, this primary encapsulation system can have a smaller number of regions. In particular, such a system can include only two regions, which are present on opposite faces of the stack.

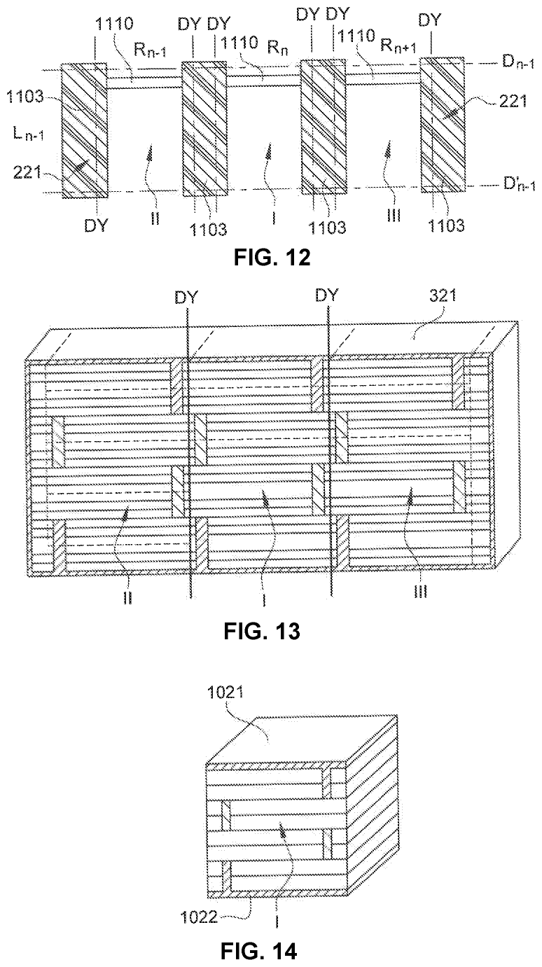

First of all, as shown in FIG. 8, the regions of the primary encapsulation system can cover only the lateral faces of the stack, which are not occupied by the contact members. Alternatively, as shown in FIG. 9, these regions of the primary encapsulation system can cover only the end faces of the stack, which are thus parallel to the layers forming the latter. Methods for manufacturing these batteries shown in FIGS. 8 and 9 will be described with reference to FIG. 12 onwards.

As a preliminary remark, as is known per se, a plurality of unit stacks, such as that described hereinabove, can be produced simultaneously. This increases the efficiency of the overall method for manufacturing the batteries according to the invention. In particular, a stack having large dimensions can be produced, formed by an alternating succession of cathode and respectively anode strata, or foils.

The physical-chemical structure of each anode or cathode foil, which is of a type known, for example, in the French Patent Publication No. FR 3 091 036 filed by the applicant, does not fall within the scope of the invention and will be described only briefly. Each anode or respectively cathode foil comprises an anode active layer or respectively a cathode active layer. Each of these active layers can be solid, i.e. they can have a dense or porous nature. Furthermore, in order to prevent electrical contact between two adjacent foils, a layer of electrolyte or a separator impregnated with a liquid electrolyte is disposed on at least one of these two foils, in contact with the opposite foil. The electrolyte layer or the separator impregnated with a liquid electrolyte, not shown in the figures describing the present invention, is sandwiched between two foils of opposite polarity, i.e. between the anode foil and the cathode foil.

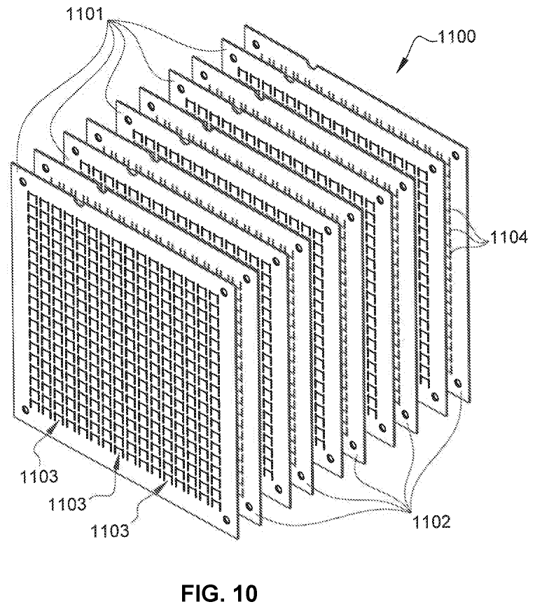

These foils or strata are indented so as to define so-called empty zones which will allow for the separation between the different final batteries. Within the scope of the present invention, different shapes can be assigned to these empty zones. As already proposed by the Applicant in the French Patent Publication No. FR 3 091 036, these empty zones can be H-shaped. The accompanying FIG. 10 shows the stack 1100 between anode foils or strata 1101 and cathode foils or strata 1102. As shown in this figure, cuts are made in these different foils to create said H-shaped anode 1103 and respectively cathode 1104 empty zones.

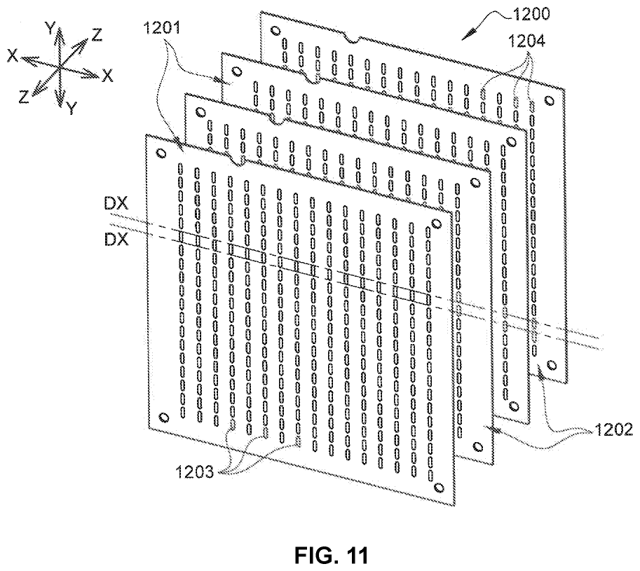

Alternatively, these free zones can also be I-shaped. The accompanying FIG. 11 shows the stack 1200 between anode foils or strata 1201 and cathode foils or strata 1202. As shown in FIG. 11, cuts are made in these different foils to create said I-shaped anode 1203 and respectively cathode 1204 empty zones.

Preferably, once the manufacture of the different unit stacks is complete, each anode and each cathode of a given battery comprises a respective primary body, separated from a respective secondary body by a space free of any electrode material, electrolyte and/or current-conducting substrate. According to an additional alternative embodiment, not shown, the empty zones can be provided such that the shapes thereof are different to a H or an I shape, such as a U shape. Nonetheless, H or I shapes are preferred.

As shown in FIG. 12, the battery in FIG. 8 can be produced using the succession of foils shown in FIG. 10. FIG. 12 shows an empty zone, on a larger scale, which is H-shaped overall. More specifically, as is known from the aforementioned French Patent Publication No. FR 3 091 036, these empty zones have vertical bars 1103, which are connected, in pairs, by horizontal channels 1110. According to this alternative embodiment, the bars 1103 receive a material 221, intended to form all or part of the primary encapsulation system.

Furthermore, as is also known from the aforementioned French Patent Publication No. 3 091 036, different unit stacks are delimited by adjacent bars. These unit stacks, which are identical to one another, are denoted by the successive references II, I and III from left to right in FIG. 12. According to this alternative embodiment, vertical cuts are then made, which are denoted by the reference DY. This not only allows the stacks to be separated from one another in a known manner, but also allows separate unit stacks covered by the lateral regions of the primary encapsulation to be obtained simultaneously. In the embodiment shown in FIG. 12, two vertical cuts DY are made, since the bars 1103 are relatively wide. According to an advantageous alternative embodiment, not shown, these bars can be produced such that they are much narrower. In such a case, a single vertical cut can be made.

As shown in FIGS. 13 and 14, the battery in FIG. 9 can be produced using the superimposition of foils shown in FIG. 11. According to a step not shown, this superimposition of foils is completely covered with an encapsulation material intended to form the primary encapsulation system. Once this covering is complete, only the unit stacks situated at the peripheral edge of the foils are covered, not only on the end faces thereof but also on some of the lateral faces thereof. By contrast, all of the “central” unit stacks are covered only on the opposite end faces thereof.

A plurality of horizontal cuts are then made, only one whereof is shown in FIG. 11 with the reference DX. Once these horizontal cuts have been made, a plurality of strips are disposed, one whereof is shown in FIG. 13. Each strip is formed by a single line of unit stacks, which are disposed next to one another.

Three adjacent stacks I, II and III are shown in FIG. 13, with the understanding that each strip comprises a significantly higher number of such stacks. Only the two unit stacks, situated at the opposite ends of each line, are covered by the encapsulation material on both the end faces thereof and some of the lateral faces thereof. By contrast, the other so-called median unit stacks are covered only on the end faces thereof.

Finally, as shown in FIG. 14, vertical cuts are made along each line. This allows a given stack to be separated from each adjacent stack. These vertical cuts produce a stack, such as the stack I in FIG. 14, wherein only the end faces are coated with the encapsulation material.

The battery according to the invention comprising such an architecture can be used as is, or integrated into an electronic circuit. Electrical contacts compatible with the solder-reflow assembly steps can be produced on the faces of the battery comprising the exposed contact members. In such a case, and as a function of the end use made of the battery, the contact members, preferably the faces of the battery according to the invention comprising the contact members, can be covered with a multi-layer system consisting of a first layer of conductive polymer, such as a conductive ink, preferably a silver-filled epoxy resin, a second layer of nickel, in particular deposited by electrodeposition on this first layer, and a third layer of tin deposited by electrodeposition on this second layer.

The first conductive polymer layer, preferably made of silver-filled epoxy resin, procures the “flexibility” at the connection without breaking the electrical contact when the electric circuit is subjected to thermal and/or vibratory stresses. The nickel layer protects the polymer layer during the welding assembly steps, and the tin layer ensures the weldability of the battery interface.

The battery according to the invention can advantageously be integrated and/or overmoulded in a flat integrated-circuit package which physically and electrically connects the integrated circuits to a printed circuit board, such as a QFN (Quad Flat No-leads package).

The battery according to the invention can be a lithium-ion microbattery, a lithium-ion mini-battery, or a high-power lithium-ion battery. In particular, it can be designed and dimensioned to have a capacity of less than or equal to about 1 mA h (commonly known as a “microbattery”), to have a power of greater than about 1 mA h up to about 1 A h (commonly known as a “mini-battery”), or to have a capacity of greater than about 1 A h (commonly known as a “high-power battery”). Typically, microbatteries are designed to be compatible with methods for manufacturing microelectronics.

The batteries of each of these three power ranges can be produced:

with layers of the “solid-state” type, i.e. without impregnated liquid or paste phases (said liquid or paste phases can be a lithium-ion conductive medium, capable of acting as an electrolyte),

or with layers of the mesoporous “solid-state” type, impregnated with a liquid or paste phase, typically a lithium-ion conductive medium, which spontaneously penetrates the layer and no longer emerges therefrom, so that the layer can be considered to be quasi-solid,

or with impregnated porous layers (i.e. layers with a network of open pores which can be impregnated with a liquid or paste phase, which gives these layers wet properties).

1-24. (canceled)

25. A battery, comprising:
an anode that includes at least one anode current-collecting substrate, at least one thin layer of an anode active material, and a thin layer of an electrolyte material or a separator impregnated with an electrolyte;
a cathode that includes at least one cathode current-collecting substrate, at least one thin layer of a cathode active material, and a thin layer of an electrolyte material or a separator impregnated with an electrolyte,
a stack, defining a plurality of faces, formed by alternating between at least one anode and at least one cathode, each formed by a stack of thin layers that successively includes the at least one anode current-collecting substrate, the at least one thin layer of the anode active material, the at least one thin layer of the electrolyte material or the separator impregnated with the electrolyte, the at least one thin layer of the cathode active material, and the at least one cathode current-collecting substrate,
wherein the plurality of faces include:
two frontal faces that are opposite and parallel to one another, generally parallel to the thin layers of the anode active material, the thin layers of electrolyte material or the separator impregnated with the electrolyte, and the thin layers of the cathode active material, and
four lateral faces that are opposite and parallel to one another in pairs,
a primary encapsulation system, covering at least two of the faces of the stack, and including two frontal encapsulation regions covering at least in part the frontal faces, and/or two lateral encapsulation regions covering at least in part two of the lateral faces, the lateral encapsulation regions being opposite and parallel to one another;
at least one anode contact member to establish an electrical contact between the stack and an external conductive element, the at least one anode contact member covering at least in part a first face of the two lateral faces not covered by the primary encapsulation system, the first face defining at least one anode connection zone;
at least one cathode contact member, arranged opposite and parallel to the at least one anode contact member, to establish an electrical contact between the stack and another external conductive element, the at least one cathode contact member covering at least in part a second face of the two lateral faces not covered by the primary encapsulation system, the second face defining at least one cathode connection zone;
a supplemental encapsulation system that includes two frontal regions that respectively cover a frontal face of the stack with an interposition of a respective frontal region of the primary encapsulation system, two lateral regions that respectively cover a lateral face of the stack with an interposition of a respective lateral region of the primary encapsulation system that is devoid of any contact member, wherein each of the two frontal regions of the supplemental encapsulation system further cover the respective frontal ends of the anode contact members and the cathode contact members and form a surface continuity with the lateral regions of the supplemental encapsulation system.

26. The battery of claim 25, wherein said primary encapsulation system comprises:
two frontal encapsulation regions covering at least part of said frontal faces, and
two lateral encapsulation regions covering all or part of two of said lateral faces.

27. The battery of claim 26, wherein each of the two frontal regions of the supplemental encapsulation system delimits two projecting edges that respectively project from a respective frontal region of the primary encapsulation system along a lateral axis of the stack, each projecting edge covering a respective end of the anode contact member or the cathode contact member.

28. The battery of claim 27, wherein:
said primary encapsulation system extends to a respective inner face of the anode contact member and the cathode contact member along said lateral axis of the stack,
said supplemental encapsulation system extends beyond said inner face as far as a respective outer face of the anode contact member and the cathode contact member,
each of the two frontal regions of the supplemental encapsulation system delimits two projecting rims which projects along another lateral axis of the stack, both from a respective frontal region of the primary encapsulation system and from the anode contact member and the cathode contact member, and
said projecting rims ensure surface continuity between the frontal regions and the lateral regions of the supplemental encapsulation system.

29. The battery of claim 25, wherein said primary encapsulation system comprises only two frontal encapsulation regions covering at least part of said frontal faces.

30. The battery of claim 25, wherein said primary encapsulation system comprises only two lateral encapsulation regions covering at least part of said lateral faces.

31. The battery of claim 25, wherein opposite ends of each respective anode contact member and the cathode contact member are flush with the frontal regions of the primary encapsulation system.

32. The battery of claim 25, wherein the primary encapsulation system comprises at least one first cover layer disposed on the stack, the at least one first cover layer being chosen from a group consisting of parylene, parylene F, polyimide, epoxy resins, silicone, polyamide, sol-gel silica, organic silica and/or a mixture thereof.

33. The battery of claim 25, wherein each of the anode contact member and the cathode contact member comprises:
a first electrical connection layer composed of a material filled with electrically conductive particles, and
a second electrical connection layer comprising a metal foil or a metal layer disposed on the first electrical connection layer.

34. The battery of claim 25, wherein:
the supplemental encapsulation system comprises an encapsulation layer composed at least one of glasses, ceramics, or glass ceramics, and
said encapsulation layer having a water vapour permeance of less than 10⁻⁵ g/m².d.

35. The battery of claim 34, wherein the glasses, ceramics, and glass ceramics of the encapsulating layer are selected from a group consisting of:
low melting point glasses that include SiO₂—B₂O₃; Bi₂O₃—B₂O₃, ZnO—Bi₂O₃—B₂O₃, TeO₂—V₂O₅, and PbO—SiO₂, and
oxides and/or nitrides and/or Ta₂O₅ and/or alumina (Al₂O₃) and/or oxynitrides and/or SixNy and/or SiO₂ and/or SiON and/or amorphous silicon and/or SiC.

36. A method of manufacturing a battery, said method comprising:
providing an anode foil that includes at least one anode current-collecting substrate foil coated with an anode layer, and optionally coated with a layer of an electrolyte material or a separator impregnated with an electrolyte;
providing a cathode foil that includes at least one cathode current-collecting substrate foil coated with a cathode layer, and optionally coated with a layer of an electrolyte material or a separator impregnated with an electrolyte;
producing a stack alternating at least one anode foil and at least one cathode foil to successively obtain at least one anode current-collecting substrate, at least one anode layer, at least one layer of an electrolyte material or a separator impregnated with an electrolyte, at least one cathode layer, and at least one cathode current-collecting substrate;
heat treating and/or mechanically compressing the stack to form a consolidated stack;
producing a primary encapsulation system to form an encapsulated and cut stack exposing at least an anode connection zone and a cathode connection zone defined by at least faces of the stack;
producing at least one anode contact member to establish an electrical contact between the stack and an external conductive element, the at least one anode contact member covering at least in part a first face of the two lateral faces not covered by the primary encapsulation system, the first face defining the anode connection zone;
producing at least one cathode contact member, arranged opposite and parallel to the at least one anode contact member, to establish an electrical contact between the stack and another external conductive element, the at least one cathode contact member covering at least in part a second face of the two lateral faces not covered by the primary encapsulation system, the second face defining the cathode connection zone;
impregnating the encapsulated and cut stack with a phase carrying lithium ions such that said separator is impregnated with an electrolyte;
placing each of the anode contact member and the cathode contact member on a respective lateral face of the stack not covered by the primary encapsulation system;
producing a supplemental encapsulation assembly to encapsulate the stack including the anode contact member and the cathode contact member; and
at least partially exposing the anode contact member and the cathode contact member to form the supplemental encapsulation system.

37. The method of claim 36, further comprising providing a primary encapsulation assembly on the stack, said primary encapsulation system being produced from said primary encapsulation assembly by making two primary cuts along first cutting planes.

38. The method of claim 36, wherein the production of the primary encapsulation system comprises depositing at least one first cover layer on the stack, the at least one first cover layer being chosen from a group consisting of parylene, parylene F, polyimide, epoxy resins, silicone, polyamide, sol-gel silica, organic silica and/or a mixture thereof.

39. The method of claim 36, wherein the production of the supplemental encapsulation system comprises depositing an encapsulation layer composed of at least one of glasses, ceramics, and glass ceramics.

40. The method of claim 36, wherein the glasses, ceramics, and glass ceramics are selected from a group consisting of:
low melting point glasses that include SiO₂—B₂O₃; Bi₂O₃—B₂O₃, ZnO—Bi₂O₃—B₂O₃, TeO₂—V₂O₅, and PbO—SiO₂, and
oxides and/or nitrides and/or Ta₂O₅ and/or alumina (Al₂O₃) and/or oxynitrides and/or SixNy and/or SiO₂ and/or SiON and/or amorphous silicon and/or SiC.

41. The method of claim 36, wherein the production of the at least one anode member and the at least one cathode contact member comprises:
depositing, on at least the anode connection zone and at least the cathode connection zone, a first electrical connection layer composed of polymeric resin filled with electrically conductive particles and/or a material obtained by a sol-gel method filled with electrically conductive particles;
drying, when said first electrical connection layer is made of polymeric resin filled with electrically conductive particles and/or a material obtained by a sol-gel method filled with electrically conductive particles, followed by polymerizing said polymeric resin and/or said material obtained by a sol-gel method; and
depositing a second electrical connection layer on the first electrical connection layer, said second electrical connection layer comprising a metal foil or a metal ink.

42. The method of claim 36, further comprising:
producing an alternating succession of respectively cathode strata and anode strata, each stratum comprising a plurality of empty zones, and
making cuts to separate a given stack of one battery from at least one other stack of another battery.

43. The method of claim 41, wherein:
the empty zones have bars connected in pairs by channels,
at least part of each bars is filled with encapsulation material, and
said cuts are made to obtain stacks having two opposite lateral faces coated with said encapsulation material.

44. The method of claim 43, wherein:
the empty zones have an overall I shape,
at least one line formed by a plurality of stacks is produced having frontal faces that are at least partially covered with the encapsulation material, and
said cuts are made to obtain stacks having frontal faces coated with said encapsulation material.
